(19) United States
(12) Patent Application Publication
(10) Pub. No.: US 2012/0314127 A1
(43) Pub. Date: Dec. 13, 2012

(54) PROVISIONING NETWORK RESOURCES RESPONSIVE TO VIDEO REQUIREMENTS OF USER EQUIPMENT NODES

(76) Inventors: Inayat Syed, Richardson, TX (US); Eric Lee Valentine, Plano, TX (US)

(21) Appl. No.: 13/156,562

(22) Filed: Jun. 9, 2011

(51) Int. Cl. H04N 7/12

(52) U.S. Cl. 348/384.1; 348/E07.045

(57) ABSTRACT

A method of controlling video from/to a User Equipment node (UE) through a network includes receiving a video mode request for transporting video from/to the UE through the network. Video requirements associated with the video mode request are identified. Network resources that need to be provisioned responsive to the identified video requirements are identified. The availability of network resources is determined An instruction is communicated to a policy charging and rules function (PCRF) node to provision network resources to transport video from/to the UE through the network responsive to the availability of network resources and the identified network resources that need to be provisioned. Related systems, network nodes, and UEs are disclosed.

### TECHNICAL FIELD

The present invention relates to communications networks. More particularly, and not by way of limitation, the present invention is directed to systems and methods of controlling video provided through a communications network to/from a user equipment node.

### BACKGROUND

There has been a rapid proliferation of cameras and other user equipment nodes that can output video through packet networks such as the Internet. For example, mobile surveillance systems are used by private entities and public safety agencies (e.g., police and fire departments) to transmit video from monitored locations.

While most surveillance video is carried by fixed networks, the increasing capabilities of wireless radio access networks allows surveillance equipment to be transported to any location where monitoring is desired, such as to the location of a fire, traffic accident, or crime scene. The surveillance equipment includes video cameras that may be configured to pan, zoom, and tilt to increase their usefulness in monitoring. Auditory monitoring equipment in the form of microphones and/or motion detection capabilities may be provided with the video cameras. Feeds from the video cameras and/or microphones may be sent to a central viewing location, where video and audio data may be recorded and monitored in real time by security personnel.

Wireless communications equipment allows mobility and fast setup for monitoring without the lead-time and costs associated with installation of a fixed communication network. Wireless communications equipment can also increase the effectiveness (e.g., “force multiplication”) of personnel by enabling persons to obtain situational awareness at many dynamically varying locations and/or by allowing enhanced monitoring opportunities, such as by reducing the predictability of what locations are being monitored by public safety personnel.

Wireless bandwidth in a communication network is a limited resource, which can be viewed as being composed of uplink resources and downlink resources. User applications typically utilize much more downlink traffic than uplink traffic, such as when a web-click transmitted in the uplink results in the download of a web page on the downlink. The opposite is typical for surveillance applications where high bandwidth video, which may include I-P-B frames and metadata and may further include audio, data are transferred on the uplink. This disparity between downlink and uplink resource requirements can lead to problems when a surveillance application attempts to transmit video through a network that is configured for user applications.

In an attempt to provide improved surveillance capabilities, the United States government and some other governments have allocated spectrum for a public safety broadband network that will comply with 3rd Generation Partnership Project (3GPP) Long Term Evolution (LTE) standards. Although the LTE public safety networks may be configured to handle some high bandwidth uplink traffic, they will experience substantial variation in traffic loading as, for example, the traffic in cells that are near a public safety incident greatly increases as the incident escalates, and then returns to more normal or average levels following the incident.

### SUMMARY

Various embodiments of the present invention may arise from the present realization that there may not presently exist any mechanisms or adequate mechanisms within networks that allow the video output requirements of a User Equipment node (UE), such as a video camera, to be mapped onto network resource provisioning mechanisms. Moreover, there may not presently exist any mechanisms or adequate mechanisms within networks that allow a plurality of video output modes that are supported by a video camera to be controlled based on what resources are available within the network. Consequently, with present networks the performance of real-time video can be unpredictable and/or have unacceptable quality.

Various embodiments of the present invention provide methods, network nodes, and UEs that are configured to allow provisioning of network resources based on the video requirements of various output modes of UEs and allow re-provisioning of the network resources responsive to changes in the output modes of the UEs. Moreover, the output modes of UEs can be controlled responsive to the resources that are presently available in a network.

In one embodiment, a method is provided in at least one network node for controlling video from/to a UE through a network. The method includes receiving a video mode request for transporting video from/to the UE through the network. Video requirements associated with the video mode request are identified. Network resources that need to be provisioned responsive to the identified video requirements are identified. The availability of network resources is determined. An instruction is communicated to a policy charging and rules function (PCRF) node to provision network resources to transport video from/to the UE through the network responsive to the availability of network resources and the identified network resources that need to be provisioned.

A related embodiment is directed to network nodes for controlling video from/to a UE through a network. The network nodes include a video stream client interface (VSCI) node and a video stream resource manager (VSRM) node. The VSCI node receives a video mode request for transporting video from/to the UE through the network, identifies video requirements associated with the video mode request, and communicates a request for provisioning of network resources responsive to the identified video requirements. The VSRM node receive the request for provisioning of network resources, determines availability of network resources, and communicates to a PCRF node an instruction to provision network resources to transport video from/to the UE through the network responsive to the request for provisioning of network resources and the availability of network resources.

Another related embodiment is directed to a network node that controls video from/to a UE through a network. The network node receives a request for provisioning of network resources for transporting video from/to the UE through the network, and determines availability of network resources responsive to the request. The network node communicates an instruction to a policy charging and rules function (PCRF) node to provision network resources to transport video from/to the UE through the network responsive to the request for provisioning of network resources and the availability of network resources.

The network node may also be configured to receive a congestion notification from the network, and to determine availability of network resources responsive to the congestion notification. The network node may determine a downgrade to the network resources that are provisioned to transport video from/to the UE through the network responsive to the determined availability of network resources after receipt of the congestion notification, and may communicate to the PCRF node another instruction for provisioning less network resources to transport video from/to the UE through the network responsive to the determined downgrade to the network resources.

Another related embodiment is directed to a UE that is configured to communicate a registration message containing information identifying the UE, a plurality of video modes supported by the UE, and requirements of each of the video modes through a network to a network node. The UE can then transmit a video mode request that identifies the UE and a requested one of the plurality of video modes supported by the UE. The UE receives a notification from the network node that indentifies that the requested one of the plurality of video modes is granted by the network node based on availability of network resources. The UE responds to the notification by operating in the requested one of the plurality of video modes to output video through the network.

Other methods, systems, network nodes, and/or user equipment nodes according to embodiments of the invention will be or become apparent to one with skill in the art upon review of the following drawings and detailed description. It is intended that all such additional methods, systems, network nodes, and/or user equipment nodes be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a telecommunications system that provisions network resources responsive to the video requirements of video cameras or other user equipment nodes and that controls video output from the video cameras;

FIG. 2 illustrates an example video data streams from the video cameras that are transported through various elements of the telecommunications system of FIG. 1;

FIG. 3 illustrates an example control flow through various elements of the telecommunications system of FIG. 1;

FIG. 4 illustrates a diagram of operations, methods and associated message flows by various nodes of the telecommunications system of FIG. 1 for initializing a video camera;

FIG. 5 illustrates a diagram of operations, methods and associated message flows by various nodes of the telecommunications system of FIG. 1 responsive to a video camera that initiates a video mode change;

FIG. 6 illustrates a diagram of operations, methods and associated message flows by various nodes of the telecommunications system of FIG. 1 responsive to an operator that initiates a video mode change;

FIG. 7 illustrates a diagram of operations, methods and associated message flows by various nodes of the telecommunications system of FIG. 1 responsive to network congestion causing a video mode change; and

FIG. 8 is a block diagram of an example node of the telecommunications system of FIG. 1 that is configured according to some embodiments.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

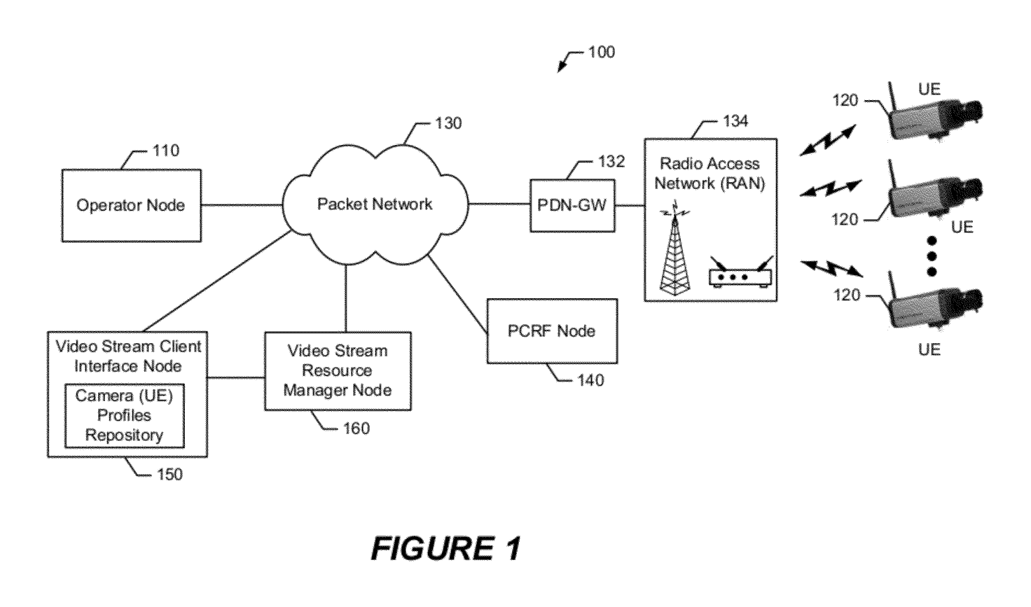

FIG. 1 is a block diagram of a telecommunications system 100 that provisions network resources responsive to the video requirements of User Equipment nodes (UE), such as the example video cameras 120, and that controls video output from the UEs according to some embodiments. Each UE may include a single video camera or a plurality of video cameras that communicate through a shared network interface module (e.g., LTE data modem or other wireless data modem). As will be explained in further detail below, a UE may include functional elements that control the output characteristics of video streams according to a plurality of defined video modes. A UE may control movement of a camera(s), zoom setting of a camera(s), and may further monitor sensors (e.g., motion sensors, alarm sensors, other event sensors, and/or location determination sensors such as GPS) and generate reports/notifications to other elements on the system 100 as will be described below. For example, the telecommunications system 100 may be used for surveillance by transporting video feeds from each of the video cameras 120 through network nodes to an operator node 110 for recording and/or monitoring by security personnel.

The network nodes can include a managed packet network 130, a Packet Data Network (PDN) Gateway (PGW) 132, a Radio Access Network (RAN) 134, and a Policy and Charging Rules Function (PCRF) node 140. The PCRF node 140 operates in real-time to determine policy rules and apply policy decisions to control Quality of Service (QoS) levels, charging, and other operational aspects for each subscriber traffic session through the network 130.

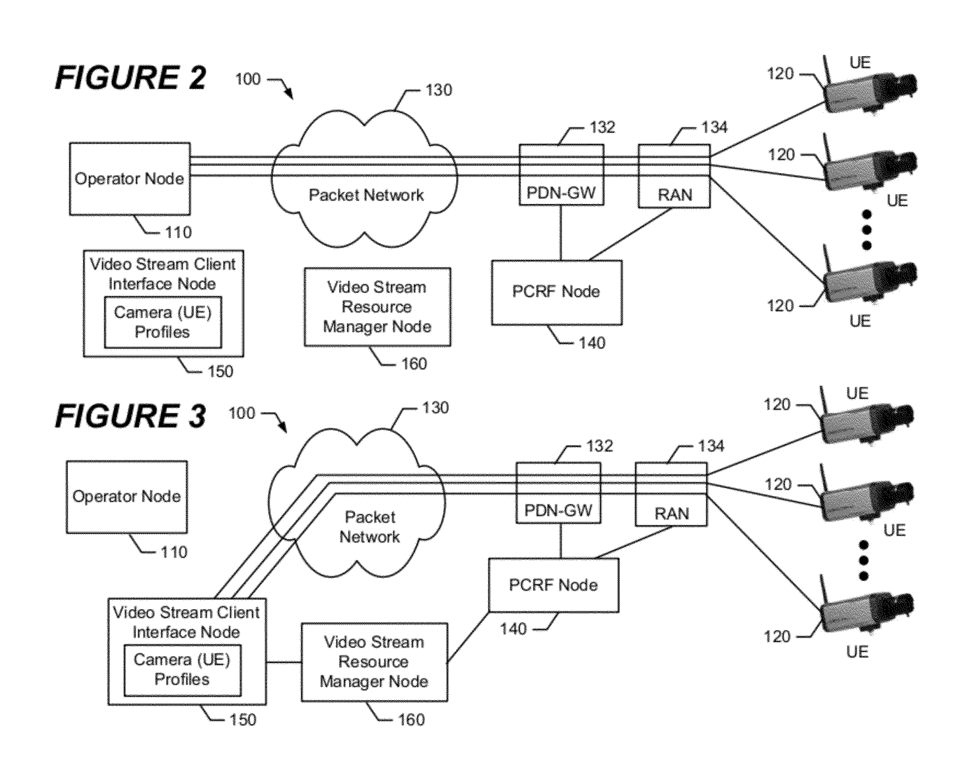

FIG. 2 illustrates example video data streams from the video cameras 120 through the RAN 134, the PDN-GW 132, and elements of the packet network 130 to the operator node 110 of the telecommunications system 100 of FIG. 1 according to some embodiments. The PCRF node 140 controls the QoS provided for transporting the video data streams through the RAN 134 and the packet network 130.

The packet network 130 may include a private network and/or public network (e.g., Internet). The RAN 134 may contain one or more cellular radio access technology systems for communicating with the video cameras 120, which may include, but are not limited to, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, Universal Mobile Telecommunications System (UMTS), and/or 3GPP LTE (3rd Generation Partnership Project Long Term Evolution). The RAN 134 may alternatively or additionally communicate with the video cameras 134 through a Wireless Local Area Network (i.e., IEEE 802.11) interface, a WinMax interface, a Bluetooth interface, and/or another radio frequency (RF) interface.

The video cameras 120 may be any type of UE that can output video, and may include, but are not limited to, cellular phones, desktop computers, laptop computers, tablet computers, palmtop computers, video gaming device or consoles, or other video output devices. Although various embodiments are described in the context of the video cameras 120 communicating wirelessly through the RAN 134, the system 100 is not limited thereto and may additionally or alternatively provide wired connections between the packet network 130 and the video cameras 120 (e.g., via a cable modem and/or Digital Subscriber Line modem).

Although various embodiments are described herein in the context of controlling resource provisioning through nodes of the system 100 for video streams that are output by various UEs (e.g., video cameras 120), it is to be understood that various embodiments herein may alternatively or additionally be applied to control resource provisioning through nodes of the system 100 for video streams that are directed to various UEs (e.g., video monitors, etc.). Accordingly, embodiments herein may be used to control video from/to UEs through network nodes.

Each of the video cameras 120 can each output video streams that have requirements that are defined by a plurality of different video modes that are supported by the video cameras 120. When a video camera 120 is active in one of the video modes, the active video mode can control certain defined characteristics and requirements of the outputted video stream. These defined characteristics and requirements may include, but are not limited to, the video resolution, the number of frames per second, the video coding (codec) used to encode the video stream, the number packets per second, the video output buffering (e.g., buffer size, overflow handling operations), and/or the bit rate of the video stream output from a video camera 120. The video modes may further include a priority marker, which indicates what priority level should be given by the network nodes (e.g., the RAN 134 and/or packet network 130) to handling a video stream from the video camera 120.

The resolution of a video stream may correspond to a number of pixels (picture elements) contained within each frame of video. For example, the video cameras 120 may operate in different modes that output varying Common Intermediate Format (CIF), QCIF, 4CIF video resolutions. The video coding (codec) of a video stream according to a particular video mode may correspond to, but is not limited to, one of the Moving Pictures Experts Group (MPEG) or Motion Joint Photographic Experts Group (MJPEG) video compression formats. A selected video mode may also cause the video camera 120 to selective utilize XML over Real Time Streaming. Protocol (RTSP) as a control protocol over Real-time Transport Protocol (RTP) for transporting commands and the video stream, although other protocols can be used. When MPEG video compression is used, the different video modes may cause the packet network 130 to handle the video stream with different priorities for I-frames (e.g., intra-coded picture frame) versus P-frames (e.g., delta-frames) d/or B-frames (e.g., Bi-predictive picture frame), and/or to handle I/P/B-frames types with a different priority than metadata, which may improve the reliability of video stream that is output by a MPEG decoder within a receiver device. Alternatively or additionally, the VSRM node 160 may control the RAN 134 to allocate different radio resources for transporting the different ones of the I/P/B-frame types and/or metadata to improve transmission efficiency and/or improve the reliability and/or timeliness with which the associated data is transported.

A video camera 120 may be configured to buffer a video stream while at a same time transmitting the video stream according to a plurality of different video modes (e.g., a plurality of output video streams having different relative video resolutions, frame rates, video coding formats, etc.). To facilitate the simultaneous communication of different video streams, the video camera 120 may include a plurality of communication modules with each communication module being used to communicate a different one of the video streams to, for example, to one or more operator nodes 110 for live viewing/analysis and/or recording.

The network communication bandwidth that is required to transport the video stream can depend upon the codec used, the resolution, the frame rate and, in the case of codecs that encodes changes between frames, the amount of change between frames. The table below illustrates example bit rates for some image resolutions and frame rates.

| Reso- | Frames per Seconds | | | | |
|---|---|---|---|---|---|
| lution | 5 FPS | 10 FPS | 15 FPS | 25 FPS | 30 FPS |
| QCIF | 25 kbps | 50 kbps | 75 kbps | 125 kbps | 150 kbps |
| CIF | 100 kbps | 200 kbps | 300 kbps | 500 kbps | 600 kbps |
| 4CIF | 400 kbps | 800 kbps | 1200 kbps | 2000 kbps | 2400 kbps |

In accordance with various embodiments, the system 100 further includes a Video Stream Client Interface (VSCI) node 150 and a Video Stream Resource Manager (VSRM) node 160. The VSCI node 150 and VSRM node 160 operate to provision (e.g., reserve for use) network resources based on the video requirements of a requested/active video mode of a video camera 120 and to re-provision network resources responsive to a change to the requested/active video mode of the video camera 120. The VSCI node 150 and VSRM node 160 may also operate to control which of the video modes of a video camera 120 is active responsive to a determination of what resources are presently available in the network 130 that can be provisioned for use in transporting the video stream. Controlling the active video mode responsive to available network resources can help ensure that the video stream is handled with adequate QoS.

The VSCI node 150 receives a video mode request for transporting video from/to a video camera 120 through the packet network 130 and the radio access network 134. The video mode request may be generated by the video camera 120 in response to the video camera 120 sensing occurrence of a defined event, such as in response to detecting movement at a monitored location, and/or from the video camera 120 being commanded (e.g., by operator node 110) to zoom to a defined level and/or being commanded (e.g., by operator node 110) to move (e.g., tilt and/or pan) to a defined position.

The video camera 120 may be configured to detect the presence of a defined object within a video frame (e.g., a vehicle license plate as the vehicle passes through the observed scene), and to change video modes to reduce communication latency and/or improve reliability of communication of the associated video stream through the packet network 130 and/or to improve the image quality or other characteristics of the video stream.

The video mode request may alternatively or additionally be generated by an operator at the operator node 110. For example, an operator may observe a person of interest in a video stream from one of the video cameras 120, and may operate the operator node 110 to generate a video mode request that requests that the referenced video camera 120 change to another video mode that provides higher quality video (e.g., high quality codec, higher video resolution, higher frame rate, higher bit rate, higher priority level, etc.) to enable recordation and/or recognition of the person's face and/or actions.

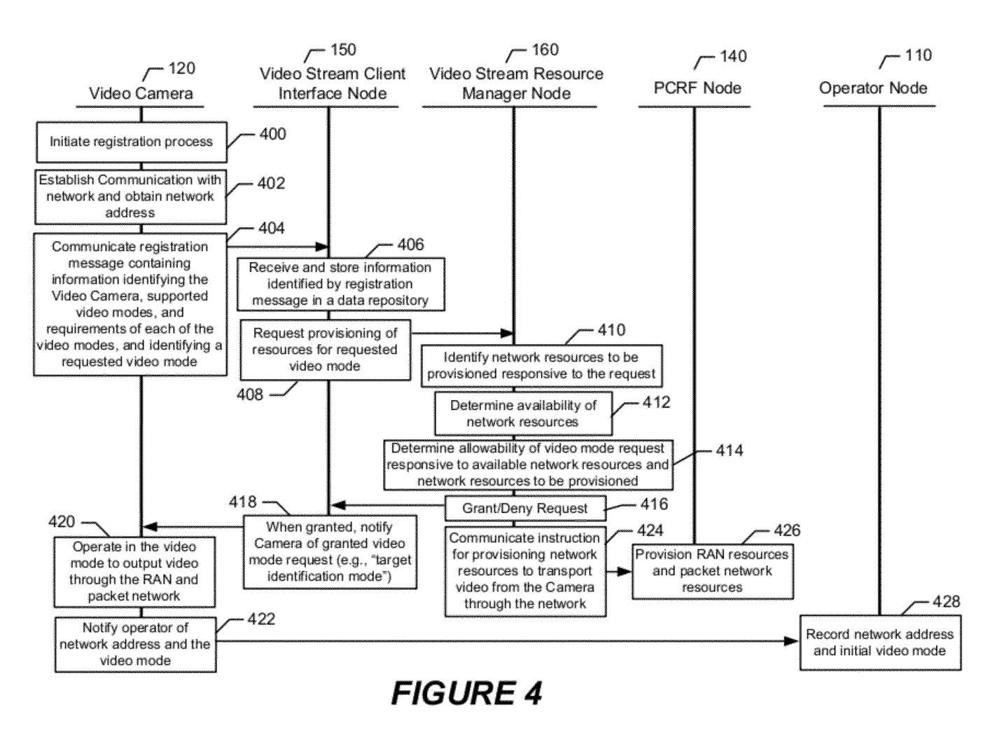

FIG. 3 illustrates example control flows between the video cameras 120, the RAN 134, the PDN-GW 132, the packet network 130, the VSCI node 150, the VSRM node 160, and the PCRF node 140. More particular examples of the control flows that can occur within the system 100 are discussed below with regard to FIGS. 4-7.

Although the VSCI node 150 and the VSRM node 160 are illustrated in the figures as being separate network nodes, they are not limited thereto. Instead, at least some of their functionality that is described herein can be combined within a single network node or may be distributed across more than two network nodes. Moreover, some of the functionality described herein for the VSCI node 150 and the VSRM node 160 may be performed within other nodes of FIG. 1, such as within the operator node 110, the PCRF node 140, and/or the video cameras 120.

The VSCI node 150 contains a camera profile repository 152 that identifies what video modes are supported by each of the video cameras 120, and further identifies the video requirements of each of the video modes. For example, the camera profile repository 152 may identify four video modes that are supported by a first one of the video cameras 120, and may further identify the video requirements (e.g., video bandwidth, video resolution, frames per second, video coding (codec), packets per second, priority of handling, and/or bit rate) of each of the four video modes (e.g., where each of the four video modes have different video requirements).

The VSCI node 150 responds to its receipt of the video mode request by identifying the video requirements associated with the video mode request, and generating a request for provisioning of network resources responsive to the identified video requirements.

The VSRM node 160 responds to the request for provisioning of network resources by determining availability of network resources, and further responds to the determined availability of network resources by generating an instruction to the PCRF node 140 to provision network resources through the packet network 130 and the RAN 134 to transport video from/to the associated video camera 120 through the packet network 130 and the RAN 134. Accordingly, the VSRM node 160 can translate the video requirements that have been identified by the VSCI node 150 for a requested/active video mode into a definition of what network resources need to be provisioned under the control of the PCRF node 140 to transport that particular video stream through the radio interface of the RAN 134 and through the element of the packet network 130.

The PCRF node 140 can respond to the instruction from the VSRM node 160 by controlling the QoS provided to a video stream for a particular one of the video cameras 120. The PCRF node 140 can use the instruction to generate a request to the RAN 134 to provision a defined level of uplink bandwidth and/or a defined prioritization for transporting through its wireless air interface the video stream from the video camera 120. For example, the PCRF node 140 can control the amount of frequency and time resource elements (e.g., Frequency-Division Multiplexing (OFDM) provisioned subcarriers) allocated by the RAN 134 for use in uplink transmissions by the video camera 120, the coding used in the uplink transmissions (e.g., coding selected to provide a defined video quality, bit error rate, bit rate, etc), and/or the prioritization at which data of the video stream is handling (e.g., to minimize delay/jitter) by the RAN 134. The PCRF node 140 can similarly use the instruction to generate a request to the PDN-GW 132 and/or nodes of the packet network 130 to provide a defined level of QoS (e.g., priority of handling through node buffers, bit error rate, jitter, packing dropping probability, bit rate, etc.) to data of the video stream from the particular video camera 120.

Each of the video cameras 120 may be associated with a different instance of the VSCI node 150. Each of the VSCI nodes 150 (when replicated) may monitor and control the active video modes and received requests for changes to the active video modes for one of the video cameras 120, or another ratio of mapping between the number of video cameras 120 that are managed by each of the VSCI nodes 150 may be used. In some embodiments, each of the VSCI nodes 150 may contain a camera profile repository 152 containing information that identifies what video modes and associated video requirements are supported by the associated video camera(s) 120.

The VSRM node 160 maintains an aggregated view of the resource requirements of the video cameras and what resources of the RAN 134 and/or the packet network 130 have been allocated to which video cameras 120 and what resources of the RAN 134 and/or the packet network 130 are available for allocating for use by one or more video cameras 120. The VSRM node 160 may selective grant or deny a particular video mode request for a particular one of the video cameras 120 received from the VSCI node 150 when the resources that are needed to support that video mode are not presently available within the RAN 134 and/or the packet network 130. The VSRM node 160 may additionally or alternatively request that the VSCI node 150 decrease the amount of resources that are used by one or more of the video cameras 120, such as by requesting a downgrade of the video mode used by the video camera(s) 120.

For example, the VSRM node 160 may be configured to receive a congestion notification from the PDN-GW 132 or another network node, and to determine the availability of network resources responsive to the congestion notification. The VSRM node 160 may determine a downgrade to the network resources that are provisioned to transport video from/to a video camera 120 through the RAN 134 and/or packet network 130 responsive to the determined availability of network resources after receipt of the congestion notification, and may generate another instruction to the PCRF node 140 for provisioning less network resources to transport video from/to the video camera 120 through the network responsive to the determined downgrade to the network resources. The VSCI node 150 may directly instruct the downgraded video camera 120 to change from an active video mode to a downgraded video mode that has less resource requirements and/or may notify the operator node 110 that the video camera 120 is being downgraded and leave it to the operator node 110 to control the downgraded video camera 120.

The VSCI node 150 and/or the operator node 110 may control a video camera 120 to change between video modes by communicating commands using one or more protocols described by the Far End Camera Control part of H.323 Annex Q and H.281 from the ITU Telecommunication Standardization Sector. By changing video modes, the codec rates can be upgraded and downgraded, temporal and/or spatial scalability can be performed, and/or the signal-to-noise (SNR) can be controlled. Temporal scalability can include skipping frames. H.323+ and MPEG-4 support the sending of multiple layers, so that the number of layers can be changed dynamically. Scaling can be performed based on the available network resources (e.g., bandwidth).

FIG. 4 illustrates a diagram of operations, methods and associated message flows by various nodes of the telecommunications system 100 of FIG. 1 for initializing a video camera 120, including populating information in the camera profile repository 152, according to some embodiments. Referring to FIG. 4, the video camera 120 initiates a registration process (block 400) in response to occurrence of a defined event (e.g., power-up and/or receiving an activation signal from a user/operator). The video camera establishes communication (block 402) with the RAN 134 and packet network 130 and obtains a network address. The video camera 120 then communicates (block 404) to the VSCI node 150 a registration message containing information that identifies the video camera 120, video modes that supported by the video camera 120, and resource requirements of each of the video modes. The communication from the video camera 120 may further identify a requested video mode for initial operation of the video camera 120.

The VSCI node 150 receives (block 406) the information from the registration message identifying the UE, a plurality of video modes supported by the UE, and requirements of each of the video modes, and stores the information in,the camera profile repository 152 which may reside in the VSCI node 150. The VSCI node 150 can access the camera profile repository 152 to identifies the video requirements associated with the requested video mode, and can communicate (block 408) to the VSRM node 160 a request for provisioning of resources in response to the requested video mode and associated video requirements.

The VSRM node 160 identifies (block 410) what network resources need to be provisioned responsive to the identified video requirements, and determines (block 412) the availability of resources within the RAN 134 and/or the packet network 130. The VSRM node 160 determines (block 414) the allowability of the requested video mode responsive to the determined availability of the network resources and the identified network resources that need to be provisioned. The VSRM node 160 can selectively grant or deny (block 416) the requested video mode in response to the determined allowability, and can communicate a grant/deny notification to the VSCI node 150. The VSCI node 150 can respond to the grant/deny notification by communicating (block 418) a notification to the video camera 120 when the requested video mode request has been granted. The video camera 120 can respond to receiving a grant of the requested video mode by operating (block 420) in the granted video mode to output video through the RAN 134 and the packet network 130. The video camera 120 may communicate (block 422) a notification to an operator at the operator node 110 that identifies the network address of the video camera 120 and the granted video mode. The operator node 110 can record (block 428) the network address and the granted video mode of the video camera 120.

In response to granting the requested video mode (block 416), the VSRM node 160 can communicate (block 424) to the PCRF node 140 an instruction to provision the identified network resources to transport video from/to the video camera 120 through the network responsive to the determined availability of network resources and the identified network resources that need to be provisioned. The PCRF node 140 can respond (block 426) to the instruction by provisioning resources in the RAN 134 to transport the video through a wireless air interface from the video camera 120 and/or by provisioning resources in the packet network 130 to transport the video from the RAN 134 through nodes of the packet network 130.

In some embodiments, during or after the registration process (blocks 400-408), the video camera 120 may determine the video carrying capabilities of the packet network 130 (e.g., presently available QoS or other capabilities determined from information that may be broadcast on a broadcast channel or other messaging of the packet network 130). The video camera 120 may then select among the plurality of video modes for outputting video through the packet network 130responsive to the determine video carrying capabilities of the network. For example, the video camera 120 may determine whether it is communicating with a home network or a roaming network and may select among the video modes responsive to that determination.

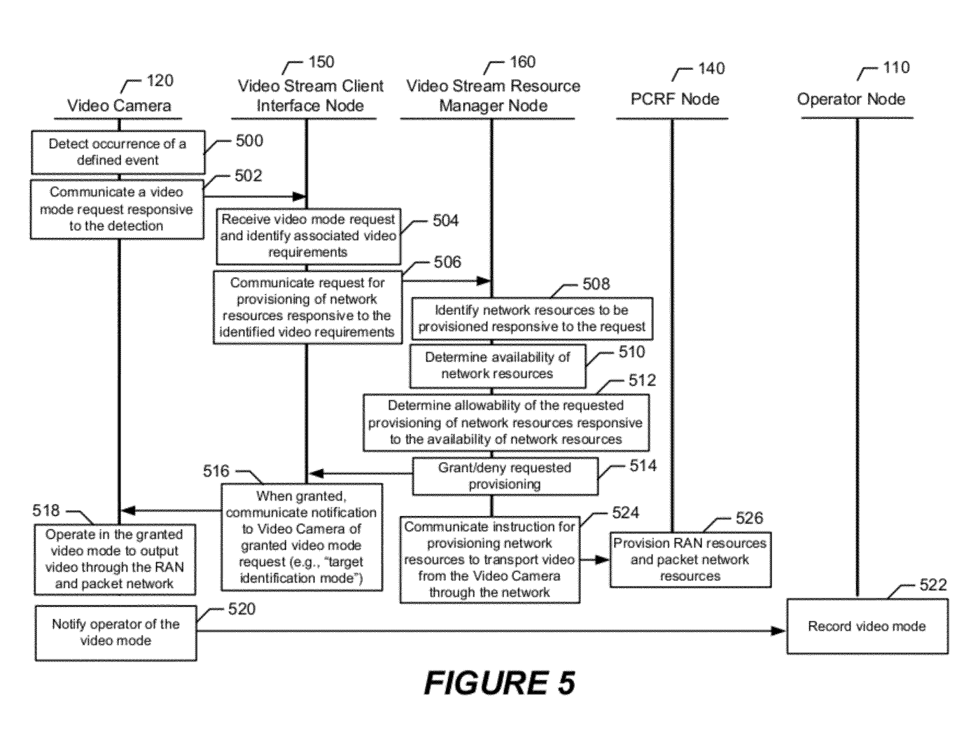

FIG. 5 illustrates a diagram of operations, methods and associated message flows by various nodes of the telecommunications system 100 of FIG. 1 responsive to a video camera 120 initiating a change in what video mode it operates to output a video stream. Referring to FIG. 5, the video camera 120 detects (block 500) occurrence of a defined event (e.g., sensed motion, camera zoom setting, camera position command, etc.). The video camera 120 communicates (block 502) a video mode request responsive to the defined event.

The VSCI node 150 receives the video mode request (block 504) and identifies the associated video requirements, such as by performing a table lookup of the video requirements defined in the camera profile repository 152 using the requested video mode. The VSCI node 150 communicates (block 506) to the VSRM 160 a request for provisioning of network resources responsive to the identified video requirements.

The VSRM node 160 identifies (block 508) what network resources need to be provisioned responsive to the identified video requirements, and determines (block 510) the availability of resources within the RAN 134 and/or the packet network 130. The VSRM node 160 determines (block 512) the allowability of the requested video mode responsive to the determined availability of the network resources and the identified network resources that need to be provisioned. The VSRM node 160 can selectively grant or deny (block 514) the requested video mode in response to the determined allowability, and can communicate a grant/deny notification to the VSCI node 150. The VSCI node 150 can respond to the grant/deny notification by communicating (block 516) a notification to the video camera 120 when the requested video mode request has been granted. The video camera 120 can respond to receiving a grant of the requested video mode by operating (block 518) in the granted video mode to output video through the RAN 134 and the packet network 130. The video camera 120 may communicate (block 520) a notification to an operator at the operator node 110 that identifies the network address of the video camera 120 and the granted video mode. The operator node 110 can record (block 522) the network address and the granted video mode of the video camera 120.

In response to granting the requested video mode (block 514), the VSRM node 160 can communicate (block 524) to the PCRF node 140 an nstruction to provision the identified network resources to transport video from/to the video camera 120 through the network responsive to the determined availability of network resources and the identified network resources that need to be provisioned. The PCRF node 140 can respond (block 526) to the instruction by provisioning resources in the RAN 134 to transport the video through a wireless air interface from the video camera 120 and/or by provisioning resources in the packet network 130 to transport the video from the RAN 134 through nodes of the packet network 130.

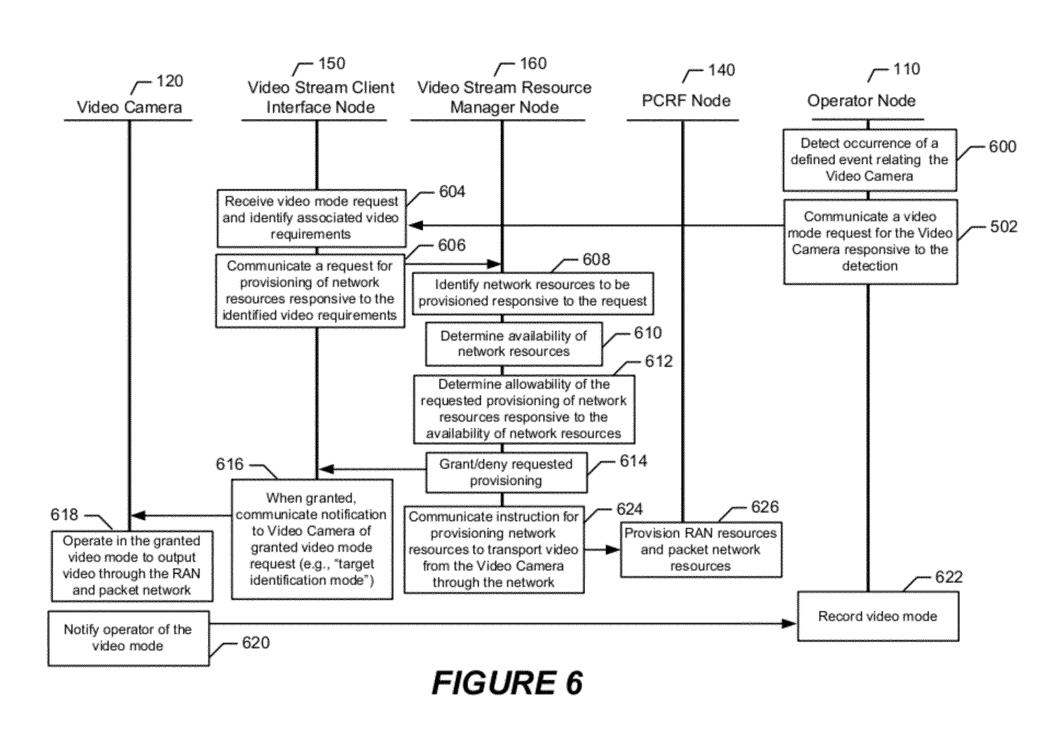

FIG. 6 illustrates a diagram of operations, methods and associated message flows by various nodes of the telecommunications system 100 of FIG. 1 responsive to the operator node 110 initiating a video mode change for a video camera 120. Referring to FIG. 6, the operator node 110 detects (block 500) occurrence of a defined event (e.g., responsive to a human operator observing an event in a video stream from the video camera 120 and/or an automated module that monitors for occurrence of sensed motion, camera zoom setting, camera position command, etc.). The operator node 110 communicates (block 602) a video mode request for the video camera 120 responsive to the detected occurrence of the defined event.

The VSCI node 150 receives the video mode request (block 604) and identifies the associated video requirements, such as by performing a table lookup of the video requirements defined in the camera profile repository 152 using the requested video mode. The VSCI node 150 communicates (block 606) to the VSRM 160 a request for provisioning of network resources responsive to the identified video requirements.

The VSRM node 160 identifies (block 608) what network resources need to be provisioned responsive to the identified video requirements, and determines (block 610) the availability of resources within the RAN 134 and/or the packet network 130. The VSRM node 160 determines (block 612) the allowability of the requested video mode responsive to the determined availability of the network resources and the identified network resources that need to be provisioned. The VSRM node 160 can selectively grant or deny (block 614) the requested video mode in response to the determined allowability, and can communicate a grant/deny notification to the VSCI node 150.

The VSCI node 150 can respond to the grant/deny notification by communicating (block 616) a notification to the video camera 120 when the requested video mode request has been granted. The video camera 120 can respond to receiving a grant of the requested video mode by operating (block 618) in the granted video mode to output video through the RAN 134 and the packet network 130. The video camera 120 may communicate (block 620) a notification to an operator at the operator node 110 that identifies the network address of the video camera 120 and the granted video mode. The operator node 110 can record (block 622) the granted video mode of the video camera 120.

In response to granting the requested video mode (block 614), the VSRM node 160 can communicate (block 624) to the PCRF node 140 an instruction to provision the identified network resources to transport video from/to the video camera 120 through the network responsive to the determined availability of network resources and the identified network resources that need to be provisioned. The PCRF node 140 can respond (block 626) to the instruction by provisioning resources in the RAN 134 to transport the video through a wireless air interface from the video camera 120 and/or by provisioning resources in the packet network 130 to transport the video from the RAN 134 through nodes of the packet network 130.

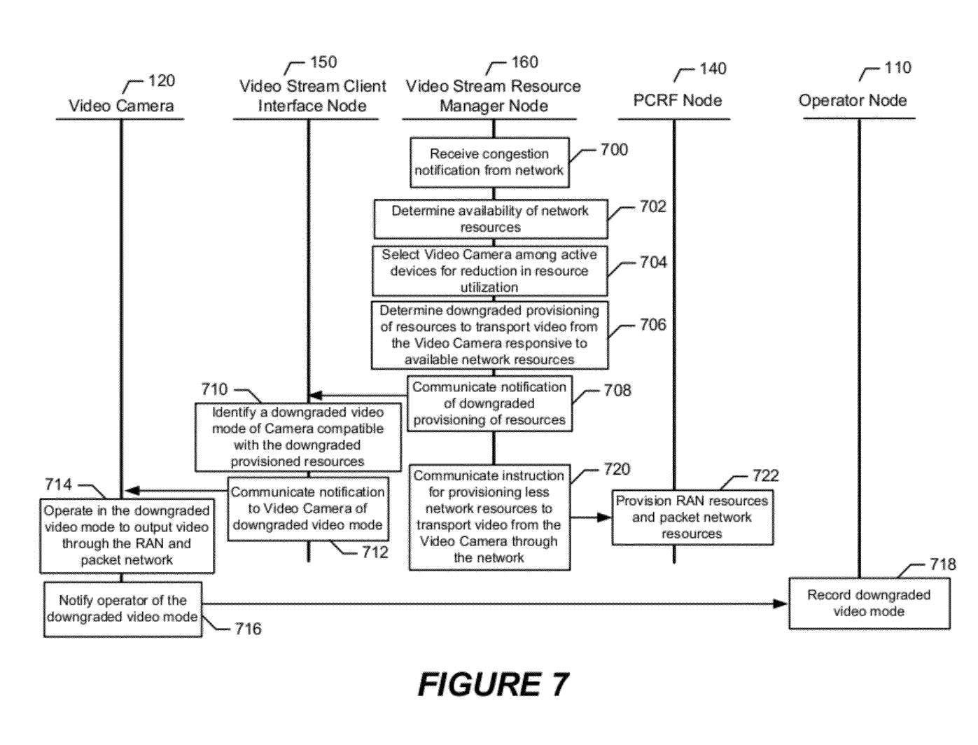

FIG. 7 illustrates a diagram of operations, methods and associated message flows by various nodes of the telecommunications system 100 of FIG. 1 responsive to network congestion causing a video mode change. Referring to FIG. 7, the VSRM node 160 receives a congestion notification from one or more network nodes (e.g., the RAN 134, the PCRF node 140, and/or the PDN-GW 132) that indicates that the network node(s) have become congested or are about to become congested (e.g., due to an increase in traffic from other UEs). The VSRM node 160 determines (block 702) the availability of resources within the RAN 134 and/or the packet network 130. The VSRM node 160 selects (block 704) a video camera 120 among active ones of the video cameras 120 (e.g., video cameras that are presently outputting video streams through the RAN 134 and packet network 130, and performs steps to reduce the resources that are utilized by the selected video camera 120. The VSRM node 160 determines (block 706) a downgraded provisioning of resources that will be used to transport video from the selected video camera 120. A notification of the downgraded provisioning of resources is communicated (block 708) from the VSRM node 160 to the VSCI node 150.

The VSCI node 150 identifies (block 710) a downgraded video mode of the selected video camera 120 that is compatible with the determined downgrade to the network resources (e.g. by performing a table lookup in the camera profile repository 152), and communicates (block 712) a notification to the selected video camera 120 of the downgraded video mode.

The selected video camera 120 can respond to the notification by operating (block 714) in the downgraded video mode to output video through the RAN 134 and the packet network 130. The video camera 120 may communicate (block 716) a notification to an operator at the operator node 110 that identifies the network address of the video camera 120 and the downgraded video mode. The operator node 110 can record (block 718) the downgraded video mode of the video camera 120.

In response to granting the requested video mode (block 614), the VSRM node 160 can communicate (block 624) to the PCRF node 140 an instruction to provision the identified network resources to transport video from/to the video camera 120 through the network responsive to the determined availability of network resources and the identified network resources that need to be provisioned. The PCRF node 140 can respond (block 626) to the instruction by provisioning resources in the RAN 134 to transport the video through a wireless air interface from the video camera 120 and/or by provisioning resources in the packet network 130 to transport the video from the RAN 134 through nodes of the packet network 130.

In response to downgrading the provisioning of resources for the selected video camera 120 (block 708), the VSRM node 160 can communicate (block 720) to the PCRF node 140 an instruction to provision less network resources to transport video from the selected video camera 120 through the RAN 132 and/or the packet network 130. The PCRF node 140 can respond (block 722) to the instruction by provisioning less network resources in the RAN 134 to transport the video through a wireless air interface from the video camera 120 and/or by provisioning less resources in the packet network 130 to transport the video from the RAN 134 and the video camera 120 through nodes of the packet network 130.

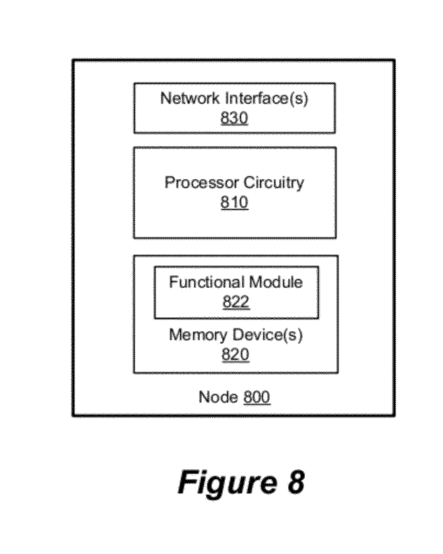

FIG. 8 is a block diagram of an example node of the telecommunications system 100 of FIG. 1 that is configured according to some embodiments. The node 800 may be used in one or more of the nodes of the telecommunications system 100 of FIG. 1, including, but not limited to, the video camera 120, the RAN 134, the PDN-GW 132, the packet network 130, the operator node 110, the VSCI node 150, the VSRM node 160, and/or the PCRF node 140. The node 800 can include one or more network interfaces 830, processor circuitry 810, and memory circuitry/devices 820 that contain functional modules 822.

The processor circuitry 810 may include one or more data processing circuits, such as a general purpose and/or special purpose processor (e.g., microprocessor and/or digital signal processor). The processor circuitry 810 is configured to execute computer program instructions from the functional modules 822 in the memory circuitry/devices 820, described below as a computer readable medium, to perform some or all of the operations and methods that are described above for one or more of the embodiments, such as one or more of the embodiments of FIGS. 1-7. Accordingly, the processor circuitry 810 can be configured by execution of the computer program instructions in the functional modules 822 to carry out at least some of the functionality described herein to provide methods and apparatus for controlling provisioning and use of resources in the RAN 134 and the packet network 130 for transporting video from/to the video cameras 120 or other UEs of the telecommunications system 100.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When a node is referred to as being “connected”, “coupled”, “responsive”, or variants thereof to another node, it can be directly connected, coupled, or responsive to the other node or intervening nodes may be present. In contrast, when an node is referred to as being “directly connected”, “directly coupled”, “directly responsive”, or variants thereof to another node, there are no intervening nodes present. Like numbers refer to like nodes throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A method performed by at least one network node for controlling video from/to a User Equipment node, UE, through a network, the method comprising the steps of:
receiving a video mode request for transporting video from/to the UE through the network;
identifying video requirements associated with the video mode request;
identifying network resources that need to be provisioned responsive to the identified video requirements;
determining availability of network resources; and
communicating to a policy charging and rules function, PCRF, node an instruction to provision the identified network resources to transport video from/to the UE through the network responsive to the availability of network resources and the identified network resources that need to be provisioned.

2. The method of claim 1, wherein:
a video stream client interface, VSCI, node receives the video mode request, identifies the video requirements associated with the video mode, and communicates a request for provisioning of network resources responsive to the identified video requirements; and
a video stream resource manager, VSRM, node receives the request for provisioning of network resources, identifies the network resources that need to be provisioned, determines the availability of network resources, and communicates the instruction to the PCRF node to provision network resources to transport video from/to the UE through the network responsive to the request for provisioning of network resources and the determined availability of network resources.

3. The method of claim 1, further comprising the steps of:
receiving the instruction to provision resources at the PCRF node; and
operating the PCRF node to provision resources in the network to transport video from the UE through the network.

4. The method of claim 3, wherein the step of operating the PCRF node to provision resources in the network to transport video from the UE through the network comprises the steps of:
provisioning radio access network, RAN, resources to transport the video through a wireless air interface from/to the UE; and
provisioning packet network resources to transport the video from/to the RAN through packet network elements.

5. The method of claim 3, wherein the step of operating the PCRF node to provision resources in the network to transport video from the UE through the network comprises the steps of:
provisioning resources in the network to transport different types of video frames and/or metadata with different communication priority levels.

6. The method of claim 1, further comprising the steps of:
determining allowability of the video mode request responsive to the determined availability of network resources and the identified network resources that need to be provisioned; and
communicating a notification to the UE of a grant of the video mode request responsive to the determined allowability of the video mode request.

7. The method of claim 6, further comprising the steps of:
operating the UE in a video mode identified by the notification to output video to the network.

8. The method of claim 6, wherein the step of receiving a video mode request for transporting video from/to the UE through the network comprises:
receiving at a video stream client interface, VSCI, node the video mode request from an operator node that is connected to the UE through the network.

9. The method of claim 1, further comprising the steps of:
receiving at a network node a registration message containing information identifying the UE, a plurality of video modes supported by the UE, and requirements of each of the video modes; and
storing the information identifying the UE, the plurality of video modes supported by the UE, and the requirements of each of the video modes in a data repository associated with the network node.

10. The method of claim 9, wherein:
the step of receiving a video mode request comprises receiving a UE identifier and a video mode identifier; and
the step of identifying video requirements associated with the video mode request comprises accessing the data repository using the UE identifier and the video mode identifier to identify associated video requirements.

11. The method of claim 1, further comprising:
receiving a congestion notification from the network;
determining availability of network resources responsive to the congestion notification;
determining a downgrade to the network resources that are provisioned to transport video from/to the UE through the network responsive to the determined availability of network resources after receipt of the congestion notification; and
communicating to the PCRF node another instruction for provisioning less network resources to transport video from/to the UE through the network responsive to the determined downgrade to the network resources.

12. The method of claim 11, further comprising the steps of:
identifying a downgraded video mode of the UE that is compatible with the determined downgrade to the network resources; and
communicating a notification to the UE of the downgraded video mode.

13. The method of claim 12, further comprising the step of:
operating the UE in the downgraded video mode to output video to the network responsive to the notification.

14. Network nodes for controlling video from/to a User Equipment node, UE, through a network, the network nodes comprising:
a video stream client interface, VSCI, node that is configured to:
receive a video mode request for transporting video from/to the UE through the network;
identify video requirements associated with the video mode request; and
communicate a request for provisioning of network resources responsive to the identified video requirements; and
a video stream resource manager, VSRM, node that is configured to:
receive the request for provisioning of network resources;
determine availability of network resources; and
communicate to a policy charging and rules function, PCRF, node an instruction to provision network resources to transport video from/to the UE through the network responsive to the request for provisioning of network resources and the availability of network resources.

15. The network nodes of claim 14, wherein the VSRM node is further configured determine allowability of the request for provisioning of network resources responsive to the identified video requirements and the availability of network resources; and
communicate to the UE a notification of a grant of the video mode request responsive to the determined allowability of the request for provisioning of network resources.

16. The network nodes of claim 14, wherein the VSCI node is further configured to:
receive the video mode request from an operator node that is connected to the UE through the network.

17. The network nodes of claim 14, wherein the VSCI node is further configured to:
receive a registration message containing information identifying the UE, a plurality of video modes supported by the UE, and requirements of each of the video modes; and
store the information identifying the UE, the plurality of video modes supported by the UE, and the requirements of each of the video modes in a data repository.

18. The network nodes of claim 17, wherein the VSCI node is further configured to:
identify a UE identifier and a video mode identifier from the video mode request; and
identify the video requirements associated with the video mode request by accessing the data repository using the UE identifier and the video mode identifier.

19. The network nodes of claim 14, wherein the VSRM node is further configured to:
receive a congestion notification from the network;
determine availability of network resources responsive to the congestion notification;
determine a downgrade to the network resources that are provisioned to transport video from/to the UE through the network responsive to the determined availability of network resources after receipt of the congestion notification; and
communicate another instruction to the PCRF node for provisioning less network resources to transport video from/to the UE through the network responsive to the determined downgrade to the network resources.

20. The network nodes of claim 14, wherein the VSCI node is further configured to:
identify a downgraded video mode of the UE that is compatible with the determined downgrade to the network resources; and
communicate a notification to the UE of the downgraded video mode.

21. A network node that controls video from/to a User Equipment node, UE, through a network, the network node is configured to:
receive a request for provisioning of network resources for transporting video from/to the UE through the network;
determine availability of network resources responsive to the request; and
communicate to a policy charging and rules function, PCRF, node an instruction to provision network resources to transport video from/to the UE through the network responsive to the request for provisioning of network resources and the availability of network resources.

22. The network node of claim 21, wherein the network node is further configured to:
receive a congestion notification from the network;
determine availability of network resources responsive to the congestion notification;
determine a downgrade to the network resources that are provisioned to transport video from/to the UE through the network responsive to the determined availability of network resources after receipt of the congestion notification; and
communicate to the PCRF node another instruction for provisioning less network resources to transport video from/to the UE through the network responsive to the determined downgrade to the network resources.

23. A User Equipment node (UE) that is configured to:
communicate a registration message containing information identifying the UE, a plurality of video modes supported by the UE, and requirements of each of the video modes through a network to a network node;
communicate a video mode request that identifies the UE and a requested one of the plurality of video modes supported by the UE;
receive a notification from the network node that identifies that the requested one of the plurality of video modes is granted by the network node based on availability of network resources; and
operate the UE in the requested one of the plurality of video modes to output video through the network in response to the notification.

24. The UE of claim 23, further configured to:
determine video carrying capabilities of the network; and
select the requested one of the plurality of video modes responsive to the determined video carrying capabilities of the network.
